(19) United States
(12) Patent Application Publication
(10) Pub. No.: US 2003/0110078 A1
(43) Pub. Date: Jun. 12, 2003

(54) System and method for broadcast advertising

(75) Inventors: Matthew Chang, San Diego, CA (US); Greg Gudorf, San Diego, CA (US); Aaron Dew, San Diego, CA (US); Anthony Lionel Creed, San Diego, CA (US); Rolf Toft, San Francisco, CA (US)

Correspondence Address: Rogitz & Associates, 750 B Street, Suite 3120, San Diego, CA, 92101, US

(73) Assignees: SONY CORPORATION, Tokyo (JP); SONY ELECTRONICS INC., Park Ridge, NJ

(21) Appl. No.: 10/003,731

(22) Filed: Oct. 29, 2001

(51) Int. Cl. G06F 17/60; H04N 7/08; H04N 5/445

(52) U.S. Cl. 705/14; 705/27; 348/473; 725/60

(57) ABSTRACT

A system and method for broadcast advertising includes a broadcast receiver that receives a broadcast signal. In addition to the usual video and/or audio data, the broadcast signal includes embedded product or service data. Moreover, the broadcast receiver includes a memory slot that is sized and shaped to receive a portable memory media. In response to a signal received at the broadcast receiver, e.g., from a remote control unit, the embedded product data is extracted from the broadcast signal and downloaded to the portable memory media forming a virtual shopping list. To facilitate shopping, the portable memory media can then be installed in a shopping computer, e.g., in an information kiosk at a shopping mall to determine where a particular product can be found, how much it costs, etc.

### BACKGROUND OF THE INVENTION

1. Field of the Invention

The present invention relates generally to broadcast systems such as television broadcast systems and radio broadcast systems.

2. Description of the Related Art

Billions of dollars are generated annually by the sale of television and radio advertisements that are broadcasted during commercial breaks. Typically, commercials are very fleeting and only provide the viewer with limited information regarding the products that they are peddling. As a consequence, a viewer's interest may be piqued, but he or she may not know how or where to obtain the product of interest. Also, viewers often tune out commercials or perform other tasks during commercials, and if something in the commercial catches their eye or ear, it may be too late to learn anything about the product, i.e., the commercial may be over.

In either situation, if a viewer wants to know more information about a product or service, i.e., the model number of the product, the brand name of the product, the manufacturer of the product, the price of the product, the provider of the service, the cost of the service, etc., he or she must conduct time consuming outside research regarding the product or service. Since most commercials do not provide information having this level of detail, the effectiveness of conventional commercials may be limited.

Accordingly, it is an object of the present invention to provide a means by which detailed product information may be received at a broadcast receiver without altering the content of the commercials broadcasted thereon.

### SUMMARY OF THE INVENTION

A method for facilitating shopping by including embedded product data into a broadcast signal receivable by a broadcast receiver, e.g., a TV or radio receiver. In response to a user command, the product data is transferred from the broadcast receiver to a portable memory media. Then, the portable memory media can transfer data to a shopping computer to identify a product associated with the product data to which the shopper indicated interest.

In a preferred embodiment, the user command is generated using a remote control device. Moreover, the shopping computer is a kiosk. Preferably, the product data includes, but is not limited to: product type, model number, universal product code (UPC), price, brand name, country of manufacture, and/or product availability. Or, the product data can be as simple as an embedded icon, watermark, logo, or symbol that can be used as a look-up pointer.

Preferably, the method further includes embedding service data into the broadcast signal receivable by the broadcast receiver. In response to a user command, the data is transferred from the broadcast receiver to the portable memory media. Then, the portable memory media is inserted into the shopping computer to identify a service associated with the service data. Alternatively, a wireless means can be used to transfer the data to the shopping computer. In a preferred embodiment, the service data includes: service provider, cost of service, and/or availability of the service.

In a preferred embodiment, a hard copy of the product data or service data can be printed by a printer connected to the broadcast receiver or shopping computer. Moreover, the shopping computer can use the shopping data to obtain more information to facilitate shopping, e.g., physical location of the product in a store, product price, product coupons, etc. Preferably, the portable memory media is a flash memory device. Moreover, in a preferred embodiment, the remote control device includes a “shop” button and the user command is generated when the “shop” button is depressed.

In another aspect of the present invention, a system for promoting purchase of a product includes a broadcast receiver that receives a signal that has product data therein. Further, the system includes a portable memory media that is removably engageable with the broadcast receiver. Also, the portable memory media can communicate wirelessly with the broadcast receiver. A user input device triggers the storage of the product data on the portable memory media. In this aspect, the portable memory media can then be engaged with a shopping computer that is distanced from the broadcast receiver so that the shopping computer receives the product data therefrom to promote a transaction involving the product.

In yet another aspect of the present invention, a broadcast receiver, e.g., a television or radio, includes means for receiving a broadcast signal having product data embedded therein. Also, the broadcast receiver includes means for receiving at least one user command and means for transferring the data from the broadcast receiver to a portable memory means, in response to the user command.

In still yet another aspect of the present invention, the broadcast receiver can be a mobile or portable broadcast receiver, e.g., a car radio, whereby pressing a “shop” button on the broadcast receiver during a commercial saves product or service data on a portable memory media.

### BRIEF DESCRIPTION OF THE DRAWINGS

The details of the present invention, both as to its structure and operation, can best be understood in reference to the accompanying drawings, in which like reference numerals refer to like parts, and in which:

FIG. 1 is a block diagram of the system of the present invention; and

FIG. 2 is flow chart showing the method of the present invention.

### DETAILED DESCRIPTION OF THE PREFERRED EMBODIMENTS

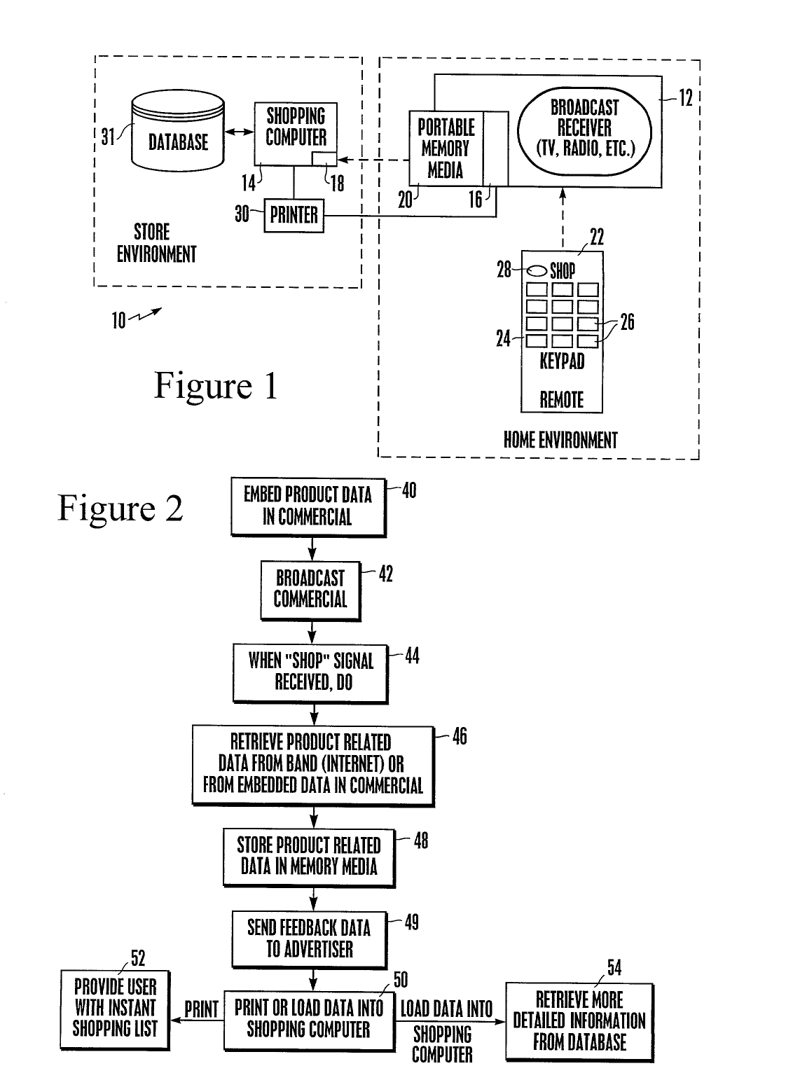

Referring initially to FIG. 1, a system is shown, generally designated 10. As shown, the system 10 includes a broadcast receiver 12 and a shopping computer or kiosk 14. It is to be understood that the broadcast receiver 12 can be a television, a radio (stationary or mobile), or any other device capable of receiving broadcast content. The broadcast receiver 12 and the computer 14 each include respective slots 16, 18 that are sized and shaped to receive a correspondingly sized and shaped portable memory media 20. It is to be appreciated that the portable memory media 18 can be installed in either the broadcast receiver 12 or the computer 14.

In a preferred embodiment, the portable memory media 18 is a flash memory device, e.g., a Memory Stick® manufactured and sold by Sony®. However, it is to be appreciated that the portable memory media 18 can be a portable random access memory (RAM) device, a portable electrically erasable programmable read-only memory (EEPROM) device, or any other similar portable media useful for transferring data or information from one device to another.

In accordance with the present invention, the broadcast receiver 12 receives broadcast content, at least a portion of which includes advertisements broadcasted during commercial breaks. Preferably, the commercial advertisements include detailed information regarding products and services that are embedded in the broadcast signal received at the broadcast receiver 12. In one exemplary, non-limiting embodiment, the detailed information is embedded in the broadcast signal much like embedded closed captioning information that is embedded in the vertical blanking interval (VBI) or other portion of the broadcast signal. The detailed product information can include, without limitation, product type, model number, universal product code (UPC), price, brand name, country of manufacture, product availability (i.e., when and where), service provider, cost of service, availability of the service, etc. Alternatively, the data may be a simple watermark, icon, logo, or symbol that is used as a pointer to retrieve more detailed information.

FIG. 1 further shows that the system 10 includes a remote control unit 22 that can be used to control the operation of the broadcast receiver 12. As shown in FIG. 1, the remote 22 includes a keypad 24 having plural hardware or software-implemented control buttons 26—one of which is a “shop” button 28. As described in detail below, when the “shop” button 28 is depressed, the detailed product and service information embedded in the commercial advertisements is downloaded to the portable memory media 20 that is installed in the broadcast receiver 12. As shown in FIG. 1, the broadcast receiver 12 and/or the computer 14 can be connected to a printer 30. Moreover, the computer 14 can be connected to a database 31.

Now referring to FIG. 2, the method steps of the present invention can be seen. Commencing at block 40, the product data or service data described above is embedded in the broadcast signal that is received at the broadcast receiver 12. Preferably, the detailed product information or service information is embedded in commercials corresponding to particular products and/or services. Moving to block 42, the commercials with the embedded content are broadcast so that they can be received at the broadcast receiver 12.

At block 44, a do loop is entered wherein when the “shop” signal is received at the broadcast receiver 12 the following steps are performed. It is to be understood that the “shop” signal is generated when the “shop” button 28 on the remote control unit 22 is depressed or otherwise toggled.

Continuing the description of the logic, when the “shop” signal is received, the logic moves to block 46 where the embedded product related information is retrieved from the commercial content. In the case of Internet TV, i.e., TV that receives Internet content as well as regular TV broadcast content, the information can be retrieved from a web server or an Internet database with which the broadcast receiver 12 is in communication via LAN, WAN, T1, or other Internet connection. Proceeding to block 48, the detailed product data is stored at the broadcast receiver 12, e.g., in the portable memory media 20. Also, at block 49, feedback can be sent to the advertisers to assist them in determining the effectiveness of, or interest in, particular commercials. Continuing to block 50, the detailed product data can be printed or uploaded to the shopping computer 14 by inserting the portable memory media 20 into the shopping computer 14. It is to be understood that the product data can be uploaded to the shopping computer 14 via a wireless connection. If the detailed product information is printed, the user is provided with an instant shopping list at block 52. On the other hand, if the product information is loaded into the shopping computer, even more detailed product information can be retrieved from the database 31 connected to the shopping computer 14. This information, e.g., can include physical location of a product in a particular store, current price, similar products, coupons, stock of product, etc. This additional information can be combined with information previously stored in the portable memory media 20 and also printed.

With this in mind, it can be appreciated that a user is able to receive detailed information regarding products and/or services that are the subject of commercials. The user can then decide whether to purchase the products based on this information. If so, the information can facilitate the purchase of the products of interest.

It is to be understood that the shopping computer 14 can be located at the user's home or at a kiosk within a shopping center, mall or other shopping venue. Thus, a user can download shopping information to the portable memory media 20, as described above, carry the portable memory media 20 to, e.g., an information kiosk at a shopping center, insert the portable memory media 20 into a computer at the information kiosk and automatically find out in which stores the products corresponding to the information on the portable memory media 20 can be found.

While the particular SYSTEM AND METHOD FOR BROADCAST ADVERTISING as herein shown and described in detail is fully capable of attaining the above-described aspects of the invention, it is to be understood that it is the presently preferred embodiment of the present invention and thus, is representative of the subject matter which is broadly contemplated by the present invention, that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural and functional equivalents to the elements of the above-described preferred embodiment that are known or later come to be known to those of ordinary skill in the art are expressly incorporated herein by reference and are intended to be encompassed by the present claims. Moreover, it is not necessary for a device or method to address each and every problem sought to be solved by the present invention, for it is to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. section 112, sixth paragraph, unless the element is expressly recited using the phrase “means for.”

We claim:

1. A method for facilitating shopping, comprising:
embedding at least one product data into a broadcast signal receivable by a broadcast receiver;
in response to a user command, transferring the data from the broadcast receiver receiving the broadcast signal to a portable memory media; and
inserting the portable memory media into a shopping computer to identify a product associated with the product data.

2. The method of claim 1, wherein the user command is generated using a remote control device.

3. The method of claim 2, wherein the shopping computer is a kiosk.

4. The method of claim 1, wherein the product data includes at least one of the following: product type, model number, universal product code (UPC), price, brand name, country of manufacture, or product availability.

5. The method of claim 1, further comprising the acts of:
embedding at least one service data into a broadcast signal receivable by the broadcast receiver;
in response to a user command, transferring the data from the broadcast receiver receiving the broadcast signal to the portable memory media; and
inserting the portable memory media into the shopping computer to identify a service associated with the service data.

6. The method of claim 5, wherein the service data includes at least one of the following: service provider, cost of service, or availability of the service.

7. The method of claim 5, further comprising the act of:
printing a hard copy of the product data or service data.

8. The method of claim 1, wherein the portable memory media is a flash memory device.

9. The method of claim 2, wherein the remote control device includes a “shop” button, the user command being generated when the “shop” button is depressed.

10. The method of claim 1, wherein the broadcast receiver is one of the following: a television or a radio.

11. The method of claim 9, further comprising the act of:
sending feedback to an advertiser representing interest in a particular commercial when the “shop” button is depressed.

12. The method of claim 1, wherein the product data is represented by a pointer that indicates where the detailed product information can be found within a database connected to a shopping computer.

13. The method of claim 12, wherein the pointer is one of the following:
a symbol, an icon, a watermark, or a logo.

14. A system for promoting purchase of a product, comprising:
at least one broadcast receiver receiving a signal having at least one product data therein;
at least one portable memory media removably engageable with the broadcast receiver;
at least one user input device to cause the product data to be stored on the portable memory media; and
at least one shopping computer distanced from the broadcast receiver and engageable with the portable memory media to receive the product data therefrom to promote a transaction involving the product.

15. The system of claim 14, wherein the user input device is a remote control unit.

16. The system of claim 14, wherein the shopping computer is a kiosk.

17. The system of claim 14, wherein the product data includes at least one of the following: product type, model number, universal product code (UPC), price, brand name, country of manufacture, or product availability.

18. The system of claim 14, wherein the signal received at the broadcast receiver further includes at least one service data.

19. The system of claim 18, wherein the service data includes at least one of the following: service provider, cost of service, or availability of the service.

20. The system of claim 14, further comprising:
an output device connected to at least one of: the broadcast receiver or the shopping computer.

21. The system of claim 20, wherein the output device is a printer.

22. The system of claim 14, wherein the portable memory media is a flash memory device.

23. The system of claim 15, wherein the remote control device includes a “shop” button, the “shop” button being toggled to cause the product data to be stored on the portable memory media.

24. The system of claim 14, wherein the broadcast receiver is one of the following: a television or a radio.

25. The system of claim 17, wherein the shopping computer is connected to a database, the shopping computer utilizing data stored on the portable memory media to access the database to retrieve additional product data.

26. The system of claim 25, wherein the additional product data includes at least one of the following: physical location of product in a store, coupons, or similar products.

27. A broadcast receiver, comprising:
means for receiving a broadcast signal having at least one product data embedded therein;
means for receiving at least one user command; and
means for transferring the data from the broadcast receiver to a portable memory means, in response to the user command.

28. The broadcast receiver of claim 27, wherein the user command is generated using a user input means.

29. The broadcast receiver of claim 27, wherein the data is transferred from the portable memory means to a shopping means.

30. The broadcast receiver of claim 27, wherein a hard copy of the data is produced using a printing means.
